(19) United States
(12) Patent Application Publication
(10) Pub. No.: US 2010/0154713 A1
(43) Pub. Date: Jun. 24, 2010

(54) System and Method of Production for Milk Products

(75) Inventor: Talo Willem Tamminga, Cambridge (CA)

Correspondence Address: HOWREY LLP-EU, C/O IP DOCKETING DEPARTMENT, 2941 FAIRVIEW PARK DR., SUITE 200, FALLS CHURCH, VA, 22042, US

(73) Assignee: LANVI S.À.R.L., MAASSLUIS (NL)

(21) Appl. No.: 12/516,391

(22) PCT Filed: Nov. 26, 2007
(86) PCT No.: PCT/NL07/00292

§ 371 Date: May 27, 2009

(30) Foreign Application Priority Data
Nov. 27, 2006 (US) 11604369

(51) Int. Cl. A01J 5/007; B65D 85/00

(52) U.S. Cl. 119/14.02; 206/459.5

(57) ABSTRACT

A system and method for producing milk is disclosed in which animals present themselves for milking on a voluntary basis. The milk produced is handled and processed separately from milk and dairy products produced by conventional milking. Advantageous characteristics of the milk are retained and can be made available for the consumer. The production process may also be adapted to the voluntary milking facilities.

### BACKGROUND OF THE INVENTION

1. Field of the Invention

The invention relates generally to milk production and processing methods and more particularly to methods of producing milk products that are sympathetic to the needs of the dairy animal. The invention further relates to a system for processing milk and an improved milk product produced according to such methods.

2. Description of the Related Art

It is well known to produce milk by milking cows or other dairy animals using milking machines. Today, relatively little milk is produced by hand and this is of an insignificant commercial value and will not be discussed further. Most milking herds are milked twice or three times a day. This may take place in a dedicated milking parlour whereby the cows are led or driven to the milking parlour for milking and then released. The cows may be kept indoors in cowsheds or may be kept outdoors and brought to the parlour at milking time. This may vary from country to country and also according to the time of year. In intensive farming situations, the cows may be kept indoors for most of their lives and will be milked according to a demanding schedule that exhausts an animal within two or three years, after which it is slaughtered.

An alternative form of milking arrangement is the tie stall with pipeline. In such a system, the cows may be tethered and milked at their feeding station. Pipelines extend throughout the cowshed to provide milking vacuum to and transport milk from each milking device. The cows are then milked according to the particular milking scheme implemented by the farmer or dairyperson. In certain tie stall cowsheds, the animals may be let out periodically to pasture. Increasingly, in intensive farming practices, the animals are kept tied for a considerable part of their lives. Such practices are generally far from ideal for animal welfare.

More recently, robotic milking machines have been developed. These milking robots are significant since they allow the teat cups of the milking machine to be connected to the teats of the cow or other dairy animal automatically. The whole milking procedure may thus be carried out without intervention of a human operator. Although the mechanization of farming procedures may be seen by some as inhumane, the use of a robot allows greater care and freedom to be given to the animal for the following reasons.

Firstly, use of a robot allows the animal to choose when it wishes to be milked. Since a human operator is absent, there is no longer a need to adhere to a specific time table. Each cow may individually decide how frequently she wishes to be milked. For some cows this will be twice a day, for other cows three times. Voluntary milking has been shown to improve the yield of an animal and significantly avoids problems due e.g. to over distended udders.

Secondly, by allowing the cows to report for milking on a voluntary basis, the milking machine may be used more effectively. A single milking robot may serve to milk a herd of around 60 animals. The robot may therefore include further refinements and procedures that would perhaps be too expensive were they to be replicated in a multiple stall milking parlour. Furthermore, since a human operator is not present, monitoring of the animals health and the milk quality must be performed by the robot. Since robots are presently better suited for monitoring all possible faults at an early stage, the resulting standard of care is significantly improved and extremely low levels of bacteria and somatic cells are frequent in milk produced using today's robots.

Robot systems that are available at present include the Astronaut™ milking system available from Lely International and the VMS™ milking system available from DeLaval. Although robotic milking machines presently exist, the milk produced has generally been collected and processed together with milk from other sources. Any advantageous characteristics of this milk are therefore diluted and cannot be taken advantage of during the processing of the milk. These qualities can thus also not be appreciated by the consumer. In this context, it is believed that milk produced from robotic or voluntary milking machines has a different composition from milk produced by non-voluntary machines. In particular, the ability of the cows to present themselves voluntarily for milking can lead to reduced levels of stress hormones in the milk. Although in certain cases, voluntary or robotically produced dairy products may have been produced on site at individual farms, it is believed that the problems of collecting from a plurality of milking facilities and maintaining such milk separate from milk from other sources has not been addressed.

A device is known from EP-A-0628244 in which a robotic milking device is used for separating milk into different containers according to quality or composition. Various factors may be used for the separation. In particular, it may use appropriate sensors to determine the somatic cell count of the milk that could be indicative of contamination. Alternatively, the milk may be separated according to the individual animal, fat content, albumin content, colour or lactation stage. Another arrangement is suggested in EP-A-1369030 in which the milk from certain animals may be at least partially separated. By carefully monitoring the milk production of each animal, the total production of the herd may be controlled and maintained between certain criteria. This is described as useful in meeting milk production quotas in relation to quantity and composition of milk.

Since current processing facilities deal with milk from distinct sources having varying characteristics, the milk processing facility must be adapted to meet the lowest common criteria for milk supplied to it. Robotic milking machines are well adapted to testing, grading and separating the milk and can perform certain processing steps that would otherwise be performed at the dairy processing facility. In the past, since robotically produced milk was mixed with other milk, any benefits would be lost and the processing facility would thus not operate in the most efficient manner.

### BRIEF SUMMARY OF THE INVENTION

The present invention addresses these problems by providing an improved method of producing milk. The method comprises providing a plurality of voluntary milking machines, allowing dairy animals free access to visit the milking machines for the purpose of milking, milking the dairy animals, collecting the milk from the milking machines, processing the collected milk to form a processed milk product derived exclusively from the voluntary milking machines and packaging the processed milk product. The packaged milk product may then be subsequently transported and marketed as required. By separately and exclusively processing this voluntarily produced milk, it is possible to take advantage of its improved characteristics. Such characteristics may include reduced levels of stress hormones in the milk, improved fat, protein or vitamin content and lower levels of impurities and microbial contamination. This may have beneficial consequences for both the consumer and for the processing facility. Furthermore, consumers are increasingly conscious of ethical and environmental aspects related to farming. Providing and guaranteeing that dairy products have been produced according to accepted criteria has an added advantage in the marketing of such products. In this manner, individual consumers have the opportunity to influence the manner in which animals are treated according to their purchase patterns.

According to an important aspect of the invention, the voluntary milking machines are milking robots that automatically perform the milking of the dairy animals. In this manner, greater efficiency of the complete milk processing chain may be achieved and human intervention is minimised.

According to a further aspect of the invention, the milk is tested according to a criterion related to the voluntary production of milk and only the milk that satisfies the criterion is processed. Additionally or alternatively the milking machines may be present in one or more milking facilities and the milking facility is tested according to a criterion related to the voluntary production of milk and only milk from facilities that satisfy the criterion is processed. In this manner it may be ensured that adequately stringent procedures are in place to ensure that the milk indeed originates from voluntary milking facilities. A number of different criteria may be included in the testing procedure. The milk may thus be tested against animal welfare criteria, e.g. by measuring constituents in the milk that reflect the condition of the animal such as stress hormones or fat content. The milking facility may also be tested against animal welfare criteria e.g. regular inspections may be carried out to ensure that the cows are kept according to established guidelines for voluntary milking facilities. There may be different levels of criteria, covering e.g. organic production, free range production, loose stall production each requiring that different conditions be maintained.

The data tested or recorded may also include details relating to the animal condition including but not limited to combinations of any of the following: variations from its normal rhythm or variable milking periods, excessive movement in the stall, body score, feed consumption and details of its particular diet, details of the pasture and the time spent indoors or in the pasture, details of distances moved e.g. in the pasture using GPS or with a step counter, sleep details, rumination details, urine and faecal analysis, animal breed, time or day at which milking takes place, lactation stage, climatic conditions and the like. The above data may be stored in an appropriate database and used in formulating and determining compliance with the voluntary milking criteria or other criteria e.g. for separating or targeted processing of the milk. Alternatively the data may be used merely for monitoring purposes in order to follow or predict cow behaviour and welfare.

Additionally or alternatively, the criteria for testing the milk or the milking facility may include milk quality criteria, or public health criteria. The use of consistent modern robotic milking devices offers the possibility of including elevated milk quality control at the point of milking. Since all of the processed milk originates from such robots, greater harmonization of quality may be achieved allowing also a greater attention to factors affecting public health including, but not limited to: levels of noxious substances such as pesticides, dioxins and heavy metals; hormone content; fat content; protein content; butyric acid content; freezing point; free fatty acid value; melatonine content; and vitamin content. The complete process including the milking, transport, processing, packaging and distribution facilities may also be tested according to environmental criteria. Stringent environmental criteria may be defined e.g. by the coordinating organization responsible for the process. These may include criteria relating to farming and husbandry such as the care for the land and the use of environmentally acceptable products and feeds. They may also relate to the modes of transport and the fuels used and the energy efficiency and design of the processing facility. In relation to the packaging and marketing of the dairy produce, environmental criteria may dictate the nature of the packaging used, requiring it to be recyclable or reusable. As above, this data may be stored in a database and used in formulating and determining compliance with the voluntary milking criteria or other criteria e.g. for separating or targeted processing of the milk. Alternatively the data may be used merely for monitoring purposes in order to follow or predict cow behaviour and welfare.

According to a yet further aspect of the present invention, the milking machines may be present in one or more milking facilities and the processing may take place at least partially at the milking facility. As mentioned above, as a consequence of the fact that all of the animals are milked using at least partially standardized, voluntary milking devices, certain processing steps may already take place at the milking facility. This may lead to advantageous improvements in the overall efficiency of the process and may also lead to higher quality products and less wastage. Such process steps may comprise sorting, testing, grading, separating, sterilizing, pasteurizing, mixing, supplementing with additives and vitamins and the like. Data related to this treatment may also be maintained in a database e.g. together with the data mentioned above.

According to a further aspect of the present invention, there is also provided a system for processing milk comprising a plurality of voluntary milking machines to which dairy animals may have free access for the purpose of milking, a milk transport facility operatively arranged for collecting the milk from the milking machines, a milk processing facility operatively arranged for receiving the collected milk for exclusively processing the milk collected from the voluntary milking machines to form processed milk and a packaging facility operatively arranged to receive and package the processed milk. Such a system may provide the benefits of the method as described above.

According to one aspect of the system according to the invention, the milk transport facility may comprise a transportable milk tank connectable to receive milk from the milking machines and deliver milk to the milk processing facility. Such a bulk milk tanker could be substantially conventional and dedicated to the transport of voluntarily produced milk. Alternative systems using milk cans and the like may also be considered. The milk transport facility may collect only one form or quality of milk or may comprise separated or segregated containers in order to keep previously separated or graded milk separate. The milk transport facility may also collect only the milk according to the voluntary milking criteria. Other milk may be processed at the milking facility or may be taken away for processing elsewhere.

According to a desirable feature of the invention, the transport facility is operable to receive and maintain information relating to the milk being collected. In particular all or any data registered and stored by the milking facility may be transmitted or otherwise provided to the transport facility. This may be extracted from a database as described above and may take the form of batch tokens or records relating to the data collected for a batch of milk or may alternatively relate to individual tokens or records/relating to the milk of an individual animal. The tokens may be electronic tokens or in the form of labels or the like. Alternatively, batches or portions of milk may be merely marked or tagged and the data corresponding to this milk may be transmitted separately to an intended recipient e.g by standard telecommunication procedures.

According to a yet further aspect of the invention, the system may further comprise a testing facility for testing the milking machines, the milk processing facility, the milk transport facility or the packaging facility according to at least one criterion related to the voluntary production of milk. The testing facility may comprise automated or computerized testing procedures. Additionally or alternatively it may comprise human testers that investigate and record the criteria. In addition to criteria related to voluntary production, the testing facility may test the various facilities according to other criteria such as those described above. If the milking facility, transport facility and/or processing facility have their own testing apparatus, the testing facility may need only to interrogate these testing apparatus to extract the required data.

The invention further relates to a method of producing processed milk products from milk collected from dairy animals in a voluntary milking facility in which dairy animals are allowed voluntary access to visit milking machines for the purpose of milking, the method comprising collecting milk exclusively from voluntary milking facilities; processing the collected milk to form processed milk derived exclusively from the voluntary milking facilities; and packaging the processed milk product. Such a method may benefit from the advantages as outlined above in that the milk may be handled in a more efficient process. As described above, the milking machines are preferably milking robots that automatically perform the milking of the dairy animals and the milk and the whole production process may be subjected to stringent testing according to appropriate criteria.

The invention also relates to a processed and packaged milk product comprising processed milk derived exclusively from the milk of dairy animals in a voluntary milking facility, in which the dairy animals are allowed voluntary access to visit milking machines for the purpose of milking. In this sense, such a product is understood to be new in that it is distinct in terms of composition due to the fact that the cow has voluntarily given milk in a manner that e.g. reduces stress levels in the milk. Furthermore, the criteria used to test the milk and its production process will also influence the composition of the final dairy product. The milk product may be packaged to include an indication of the manner in which it has been produced and of certain criterion employed in its testing. Preferably, the package also includes an indication of the particular milking facility or herd from whence the milk has been collected. In an automated procedure it may also be desirable to include an indication of the animal that has produced the milk.

### BRIEF DESCRIPTION OF THE DRAWINGS

The features and advantages of the invention will be appreciated upon reference to the following drawings, in which:

FIG. 1 is a schematic view of an embodiment of the invention showing the various facilities involved in the production of a dairy product; and

FIG. 2 is a schematic view of part of the milk processing system of FIG. 1.

### DESCRIPTION OF ILLUSTRATIVE EMBODIMENTS

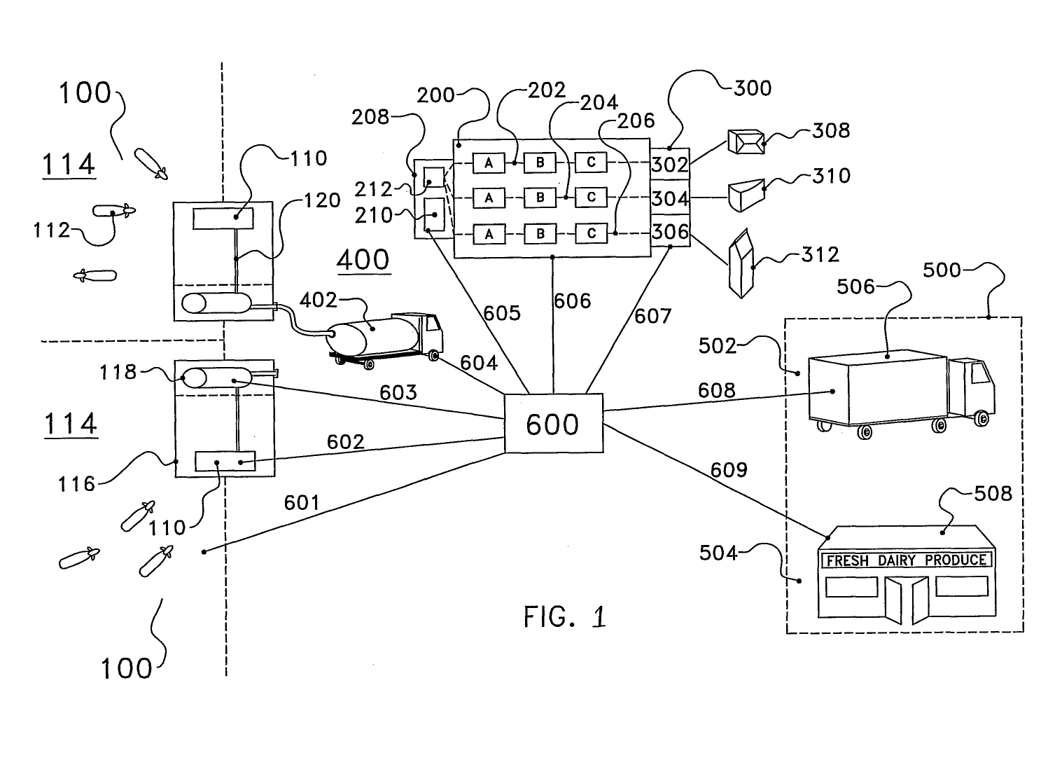

The following is a description of certain embodiments of the invention, given by way of example only and with reference to the drawing. Referring to FIG. 1, a milk processing system 1 according to a first aspect of the invention is shown comprising a plurality of milking facilities 100 each of which has a milking robot 110. For the present purpose, each milking facility 100 may be considered to be an independently operating farm. While one milking robot 110 has been shown per milking facility 100, it is also possible that a milking facility has a plurality of milking robots 110, depending on the size of the herd. Milking robots 110 are preferably of the Astronaut A3™ type, available from Lely International Inc and will not be further described at present. It is nevertheless understood that alternative voluntary milking facilities may also be used, subject to the criteria defined below. They milking robot 110 is provided with appropriate sensors as well known to the skilled person and e.g. as described in EP-A-628244, the contents of which are incorporated herein by reference in their entirety. A characteristic of the milking robots 110 is that they allow voluntary milking as and when an individual animal demands.

Cows 112 are free to graze in the pastures 114 of the milking facilities 100 and are also able to take shelter in cowsheds 116 at night or during inclement weather. For convenience and environmental protection, the milking robots 110 are also located in cowsheds 116. It is however understood that the robots 110 may also be located externally in the pastures 114 in order to provide more immediate access for the cows 112 during grazing. Also located in cowsheds 116 are milk tanks 118 for collecting, storing and cooling milk. The milk tanks 118 are connected to the milking robots 110 by milk lines 120.

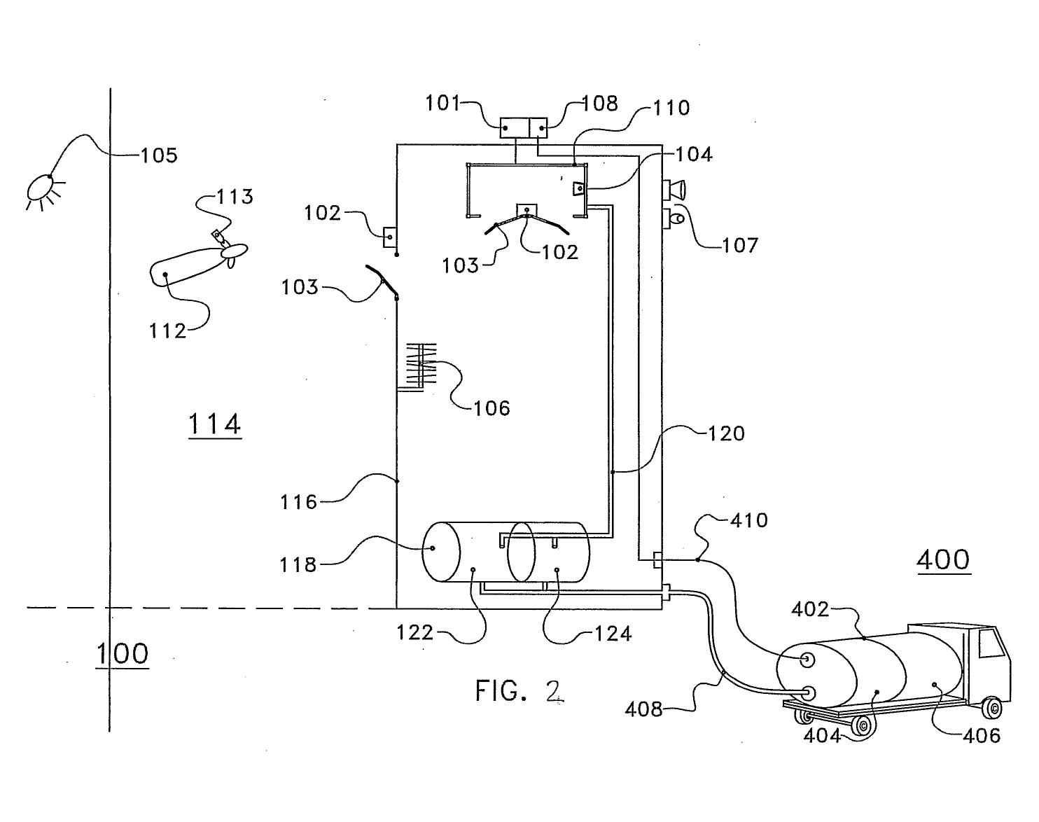

Further detail of one of the milking facilities 100 is shown in FIG. 2. According to FIG. 2 each cow can be seen to carry an identity device 113. The identity device 113 also serves as a GPS positioning beacon allowing location of the cow 112 within the pasture 114 and tracking of its movements. Within the cowshed 116, milk tank 118 comprises a voluntary milk section 122 and a further milk section 124. It will be understood that sections 122, 124 may alternatively be embodied as separate tanks and that separate milk lines may be provided for each.

Each milking facility 100 is provided with a computer 101 which controls operation of the milking facility 100. The computer 101 controls the milking robot 110 and its sensors and may also interact and/or control other features of the milking facility 100 including but not limited to: identification systems 102, gates 103, feeding arrangements 104, GPS positioning systems 105, cleaning arrangements 106 and signalling arrangements 107. The computer 101 includes a database 108 in which all relevant data related to the operation of the milking facility 110 is stored. In particular, for each individual cow 112, the database 108 comprises a record containing data including but not limited to: animal identity; milk quantity; milk quality and composition including milk fat content and free fatty acid value, milk protein content, lactic acid content, butyric acid content, freezing point, milk colour, somatic cell count, bacterial count, levels of noxious substances such as pesticides, dioxins and heavy metals, hormone content, melatonin content and vitamin content; animal condition including variations from its normal rhythm or variable milking periods, excessive movement in the stall, body condition score, feed consumption and details of its particular diet, details of the pasture and the time spent indoors or in the pasture, lactation stage, sleep details, rumination details, urine and faecal analysis; animal breed; time or day at which milking takes place; and climatic conditions.

The database 108 is able to retrieve and update data relating to an individual cow 112 based on its identity device 113. Movements of the animal in the pasture 114 may be fed back to the computer 101 and database 108 via GPS system 105. Approach of an animal to a gate 103 may be detected by identification system 102 and the gate opened if required. Feeding arrangement 104 may be actuated by computer 101 in response to arrival of a given cow 112 at the robot 110 for milking. Unfinished feed may be detected and recorded in the database 108. Milk from the robot 110 may be selectively directed to either section 122 or 124 according to the identity of the cow or any other criteria related to milk quality or as further defined herein. The skilled person will immediately appreciate that many further possible details can be measured and recorded as desired by the farmer or authorities and that appropriate sensors and systems may be included accordingly.

Located at a distance from the milking facility 100 is a processing facility 200 shown in FIG. 2. Processing facility 200 is a dairy produce processing facility having an upstream section 208 for receipt of milk from the milking facility. The upstream section 208 comprises test unit 210 and separator unit 212 in which the milk is separated into its components e.g. by centrifugation. The processing facility 200 also has process lines 202, 204, 206 for producing different dairy products including e.g. butter, cheese and milk. The butter line 202 comprises process sections 202A, 202B and 202C comprising processes necessary for the processing of butter. The process sections 202A, 202B and 202C may comprise standard processes common in the art of butter-making and will not be defined in further detail in the present application. Similarly, cheese process line 204 comprises process sections 204A, 204B and 204C comprising processes necessary for the processing of cheese. Milk process line 206 also has process sections including a reconstitution section 206A, a homogenization section 206B and a pasteurizing section 206C. These processes may be generally conventional and will not be described in further detail in the present application. Processing facility 200 is dedicated to the processing of products originating from milk produced by milking robots 110 according to voluntary milking criteria as defined below. It will be understood that further products may be processed at the processing facility 200 e.g. in a separate section for non-voluntary milk products. It will also be understood that products such as the processed milk produced by the processing facility 200 may be further processed elsewhere into further refined products such as ice cream or bakery products. The further processing may also of course be carried out exclusively according to the invention, in which case it would be subject to the same testing criteria as defined below and could be packaged and marketed accordingly.

At a downstream side of the processing facility there is provided a packaging facility 300 having packaging lines 302, 304, 306 for the packaging of the produce of the process lines 202, 204, 206 as packaged products 308, 310, 312. Although the packaging facility is referred to as a separate facility, it is understood that sections of the facility may be spatially separated at different locations according to the location of the particular process line.

FIG. 1 also indicates a milk collecting or transporting facility 400. According to the presently described embodiment, milk transporting facility 400 comprises a bulk tanker 402, adapted to receive milk from the milk tanks 118 and transport it to the upstream section 208 of the processing facility 200. FIG. 2 shows the bulk tanker 402 in more detail to comprise two separate milk compartments designated as voluntary milk compartment 404 and further milk compartment 406. The bulk tanker 402 is connected to the milk tanks by a pipe 408. According to the milk collected and its compliance with the various criteria as will be further described below, the milk will be delivered through the pipe 408 to one of these compartments 404, 406. Under normal circumstances, milk from section 122 will be delivered to compartment 404 and milk from section 124 will be delivered to compartment 406. Although not shown, it is understood that the pipe 408 may be provided with a number of channels for keeping the different milk supplies separate. In addition to carrying milk, pipe 408 provides a data connection 410 from the computer 101 and database 108 to the bulk tanker 402. In this manner, data relating to the milk may be transferred to the bulk tanker where it is maintained on an appropriate data carrier (not shown). It is also envisaged that alternative milk transporting systems could be employed which would be equivalent to or instead of the bulk tanker depicted e.g. based on the use of milk cans. Such milk cans could be provided with data in the form of electronically readable tokens, bar codes, labels or the like.

Reverting to FIG. 1, there is also illustrated a marketing facility 500. Marketing facility 500 comprises a distribution system 502 and a sales system 504. The distribution system 502 comprises refrigerated transport in the form of truck 506 and may also include other elements common to known distribution systems, including other forms of transport, warehouses and related logistics and support. Sales system 504 comprises shops 508 but may also include other elements common to existing sales systems, including on-line shops, farm outlets, restaurants and other service facilities and also advertising and the like. Unlike the other facilities hitherto described, marketing facility 500 need not be dedicated exclusively to milk and dairy products derived from milking robots 110 according to the voluntary milking principle. Other dairy produce originating from other sources may thus also be distributed and sold subject to the criteria discussed below.

As also shown in FIG. 1, the milk processing system 1 of the present invention also comprises a testing facility 600. Testing facility 600 is arranged to interact with some or all of the facilities described above as indicated by lines 601-610 in order to test aspects of the milk processing system 1 according to predetermined criteria. As an example of the criteria that may be tested, line 601 indicates testing of the pastures 114 according to environmental criteria. Line 602 indicates testing at the milk robot 110 according to milk quality criteria. Line 603 indicates the testing of the bulk tank 118 according to a time criterion. Line 604 indicates testing of the collection facility according to an identity criterion to determine whether milk received actually comes from an accepted milking facility. Line 605 indicates testing at the test unit 210 according to milk constitution criteria. Line 606 indicates testing of the processing facility 200 according to quality criteria. Line 607 indicates testing of the packaging facility according to environmental criteria. Line 608 indicates testing of the distribution system 502 according to further environmental criteria. Line 609 indicates testing of sales system 504 according to ethical criteria. The skilled person will be well aware that the criteria indicated above in relation to one process may also apply to another process and that many further criteria may also be taken into account in order to ensure that the system operates as required and meets all standards. Furthermore, although the figure discloses the testing facility 600 as being separate from and interacting with the other facilities, it will be understood that the testing facility 600 may be at least partially located in or comprised by parts of these facilities. Alternatively, testing may be performed by the facilities themselves, e.g. under the control of the computer 101 and the testing facility 600 may merely interrogate the facility for the data that it requires.

In use, the system 1 works as follows. The cows 112 graze in the pastures 114 and are able to report voluntarily to a milking robot 110 at any point in time when they desire to be milked. Arrival of a cow 112 at the milking robot 110 is detected by identification system 102 recognising identification device 113 and the milking procedure may commence. The milking procedure may comprise a number of steps including grooming, washing, pre-milking, milking, post milking, disinfecting, feeding and any other procedures that it may be appropriate to perform on the animal in question. Although generally speaking a cow 112 may report to be milked at any moment that she desires, there may nevertheless be placed limits on the number of times she may present herself within a given period. These measures are well known to the skilled practitioner in the field of milking robots and will not be further dealt with here. The milk collected by the milking robot 110 is passed via the milk line 120 to milk tank 118 where it is immediately cooled. On milking the animals, the robot 110 separates the milk according to given criteria. Milk that meets the criteria for sale as voluntary milk is directed to voluntary milk section 122 of the milk tank 118. The remaining milk is directed to the further milk section 124. In the present example it should be noted that the further milk has been produced in a voluntary milking procedure but nevertheless does not meet the elevated quality or quantity criteria for voluntary milk section 124. This may thus be seen as a way of also separating milk into two or more quality grades for subsequent separate processing. It will of course be understood that still further milk may be entirely discarded e.g. if it is deemed unsuitable for human consumption.

Within a given maximum period of time, or after a maximum amount of milk has been produced, the milk is collected by bulk tanker 402. Bulk tanker 402 has voluntary milk compartment 404 which receives milk from voluntary milk section 122. The further milk in section 124 is passed through pipe 408 to compartment 406. The voluntary milk carried by the bulk tanker 402 is thus not mixed with the further milk from other sources. On transferring the milk via pipe 408, all desired data relating to the milk being transferred is also transferred to the bulk tanker where it is maintained on an appropriate data carrier (not shown). Prior to accepting the milk, the bulk tanker 402 queries the data to determine whether it meets desired criteria or standards. In this way it can be prevented that milk that does not meet the criteria is mixed with milk already in the bulk tanker 402. The data is transferred in the form of an electronic token for each batch of milk. Nevertheless, it is understood that alternative ways of ordering and transferring the data may be used

The bulk tanker 402 delivers the voluntary milk from compartment 404 to the upstream section 208 of the processing facility 200, where it is again tested at line 605 according to whether it has been produced by an accepted milking facility and meets the required criteria. If the milk meets the criteria, it will be processed in one of lines 202, 204, 206 to an appropriate dairy product. The product is subsequently packaged by packaging facility 300. Of significance, the packaging denotes the provenance of the dairy product 308, 310, 312. It also lists some or all of the criteria that the product has been tested for based on the data provided with the milk. Milk that does not meet the criteria may be discarded or, if otherwise fit for consumption may be processed in a separate line (not shown) together with the further milk from compartment 406. This further milk is packaged as a distinct product but the packaging may also be provided with an indication denoting its provenance and some or all of the data provided with the milk.

Thereafter, the packaged products 308, 310, 312 are distributed via distribution system 502 and sold via sales system 504. During sales and distribution, the packaged products 308, 310, 312 will still be identified by their packaging and by other indicators as having come from the milking facility 100 according to the defined criteria. This is clearly beneficial for quality control purposes. Although not presently depicted, it is understood that with appropriate transport and processing facilities it may also be possible to provide an indication of the individual animal that has produced the milk.

As an indication of criteria that could be applied to the milk processing system 1 of the present invention, the following example is given:

### Example

A milk processing scheme is proposed in which the following criteria are required by all farms contributing to the scheme and by all parties in the subsequent processing of the milk and dairy products.

1. Farmers are required to comply with the following criteria regarding ethical treatment of the animals:
a. They will not be hit by foreign objects;
b. They will have comfort stalls of at least 105 cm width;
c. There will be stalls for at least 90% of the herd;
d. They will have outside access on demand (subject to health risk);
e. Medicines will be administered as prescribed by a veterinary practitioner;
f. In cases of (fatal) distress proper euthanasia will be applied on the farm.

2. The farm must comply with the following criteria regarding food safety:
a. Comfort stalls will be cleaned at least 2 times a day
b. Robot room will be cleaned at least 2 times a day
c. There will be no BST hormone use in the herd;
d. The farm and milk will otherwise comply with the local guidelines for organic milk production.

3. The farm and processing facility must comply with the following environmental criteria:
a. The farm must be local to the processing facility (within a 250 km range)
b. Milking herd size will have a maximum limit of 200 cows;
c. The milk will be packaged in either bio-degradable packages or glass bottles.

4. The farm and processing facility must comply with the following social criteria:
a. the scheme shall guarantee the dairy farmer an environment for profitable and sustainable operation;
b. the dairy worker will not work more than 48 hours weekly and will receive no less than 120% of the national minimum wage.

5. The milk must comply with the following quality criteria:
a. Fat content between 3.5 and 4.5%
b. Protein content greater than 3.0%
c. Lactose content between 4.2 and 4.8%
d. Somatic cell count below 100 000.
e Bacterial count below 5 000.

In this example, only milk from facilities meeting all of the above criteria would be eligible for processing and packaging as voluntary milk. Milk failing to meet the milk quality criteria but otherwise fit for human consumption would be processed as further milk.

Thus, the invention has been described by reference to the embodiment discussed above. It will be recognized that this embodiment is merely exemplary and is not limiting upon the scope of the invention. Alternative or additional criteria may be used for sorting and separating the milk to be processed. Further data in addition to that described above may be collected and processed for identifying and qualifying the milk. Many modifications in addition to those described above may be made to the structures and techniques described herein without departing from the spirit and scope of the invention.

1. A method of producing milk products, comprising:
providing a plurality of voluntary milking machines located at different milking facilities;
allowing dairy animals free access to visit the milking machines for the purpose of milking;
milking the dairy animals to produce milk using said milking machines;
transporting the milk from the milking facilities to a processing facility;
processing the milk to form a processed milk product derived exclusively from the voluntary milking machines; and
packaging the processed milk product.

2. The method of claim 1, wherein the voluntary milking machines are milking robots that automatically perform the milking of the dairy animals.

3. The method according to claim 1, wherein the processing facility comprises a first section dedicated to processing milk derived exclusively from the voluntary milking machines and a second section for non-voluntary milk products, wherein the milk or the milking facility is tested according to at least one criterion related to the voluntary production of milk and only the milk that satisfies the criterion is processed in the first section.

4. The method of claim 3, wherein a criterion is an animal welfare criterion.

5. The method of claim 3, wherein a criterion is a milk quality criterion.

6. The method of claim 3, wherein a criterion is a public health criterion.

7. The method of claim 3, wherein a criterion is an environmental criterion.

8. The method of claim 1, wherein the processing takes place at least partially at the milking facility.

9. The method of claim 1, further comprising collecting data related to the voluntary production of milk at the milking facilities and providing the data to the processing facility.

10. The method of claim 1, further comprising collecting further data related to the milk at the milking facilities and providing the further data to the processing facility.

11. The method of claim 10, comprising transporting the milk to the processing facility together with the data or further data.

12. The method of claim 9, further comprising marking the packaged product with an indication of the data or the further data.

13. The method of claim 1, further comprising marking the packaged product with an indication that the milk is produced according to a voluntary milking criterion.

14. A system for processing milk comprising:
a plurality of voluntary milking machines to which dairy animals may have free access for the purpose of milking;
a milk transporting facility operatively arranged for collecting milk from the milking machines;
a milk processing facility operatively arranged for receiving the collected milk for exclusively processing the milk collected from the voluntary milking machines to form a processed milk product; and
a packaging facility operatively arranged to receive and package the processed milk product.

15. The system of claim 14, further comprising a marketing facility arranged for exclusively marketing the packaged product.

16. The system of claim 14, wherein the milk transporting facility comprises a transportable milk tank connectable to receive milk from the milking machines and deliver milk to the milk processing facility.

17. The system of claim 14, further comprising a testing facility for testing the milking machines, the milk processing facility, the milk transporting facility or the packaging facility according to a criterion related to the voluntary production of milk.

18. A method of producing milk products from milk collected from dairy animals in voluntary milking facilities in which dairy animals are allowed voluntary access to visit milking machines for the purpose of milking, the method comprising:
collecting milk exclusively from the voluntary milking facilities;
processing the collected milk to form a processed milk product derived exclusively from the voluntary milking facilities; and
packaging the processed milk in a package.

19. The method of claim 18, wherein the milking machines are milking robots that automatically perform the milking of the dairy animals.

20. The method of claim 18, wherein the milk is tested according to a criterion related to the voluntary production of milk and only the milk that satisfies the criterion is processed to form the processed milk product derived exclusively from the voluntary milking facilities, and whereby milk that does not satisfy the criterion is separately processed.

21. The method of claim 20, wherein the criterion is an animal welfare criterion.

22. The method of claim 20, wherein the criterion is a milk quality criterion.

23. The method of claim 18, wherein the milking facility is tested according to at least one further criterion related to the voluntary production of milk and only milk from facilities that satisfy the further criterion is processed to form the processed milk product derived exclusively from the voluntary milking facilities, and whereby milk from facilities that do not satisfy the criterion is separately processed.

24. The method of claim 23, wherein a further criterion is an animal welfare criterion.

25. The method of claim 23, wherein a further criterion is a public health criterion.

26. The method of claim 23, wherein a further criterion is an environmental criterion.

27. The method of claim 18, further comprising marking the package with a criterion related to the voluntary production of milk.

28. The method of claim 18, further comprising marking the package with an indication identifying a particular milking facility from which the milk has been collected.

29. A package containing a processed milk product derived exclusively from the milk of dairy animals in a voluntary milking facility, in which the dairy animals are allowed voluntary access to visit milking machines for the purpose of milking, the package comprising an indication of a voluntary milking criterion related to the voluntary production of the milk.

30. The packaged milk product of claim 29, further comprising an indication identifying the milking facility.

31. The packaged milk product of claim 29, further comprising an indication of further data related to a specific animal or group of animals from which the milk was derived.
